(19) United States
(12) Patent Application Publication
(10) Pub. No.: US 2018/0115877 A1
(43) Pub. Date: Apr. 26, 2018

(54) INTER-PLATFORM MULTI-DIRECTIONAL COMMUNICATIONS SYSTEM AND METHOD

(71) Applicant: BLUELINE GRID, INC., Bethesda, MD (US)

(72) Inventors: DAVID RIKER, New York, NY (US); SERGEY TOLKACHEV, New York, NY (US); EDWARD BRAILOVSKY, New York, NY (US); VASYL KUTISHCHEV, New York, NY (US); OSCAR ALOFF, New York, NY (US); JAMES COOPER, New York, NY (US)

(21) Appl. No.: 15/795,066

(22) Filed: Oct. 26, 2017

Related U.S. Application Data
(60) Provisional application No. 62/413,322, filed on Oct. 26, 2016.
(60) Provisional application No. 62/524,741, filed on Jun. 26, 2017.

(51) Int. Cl. H04W 4/14; H04W 4/02; H04W 4/00

(52) U.S. Cl. CPC H04W 4/14; G06F 13/20; H04W 4/001; H04W 4/02

(57) ABSTRACT

A computer implemented method of inter-platform bi-directional collaboration includes obtaining a set of cross-platform encoding parameters, obtaining a first communication message in a first message format corresponding to from a first communication platform, translating, with a collaboration interface logical circuit, the first communication message to a second message format corresponding to a second communication platform, and transmitting the first communication message in the second message format to the second communication platform.

### CROSS-REFERENCE TO RELATED APPLICATIONS

The present application claims the benefit of U.S. Provisional Patent Application No. 62/413,322 filed on Oct. 26, 2016 and entitled “Systems and Methods for Environmental Context Defined Collaboration” and U.S. Provisional Patent Application No. 62/524,741 filed on Jun. 26, 2017, entitled “Inter-Platform Multi-Directional Communication System and Method,” both of which are incorporated herein by reference in their entirety.

### TECHNICAL FIELD

The disclosed technology relates generally to communications systems, and more particularly, some embodiments relate to inter-platform multi-directional communication systems and methods.

### BACKGROUND

With the rising popularity of the smartphone, mobile device-based communication tools have become increasingly prevalent. These types of communications tools have also become viable mechanisms for communicating with groups of people, for example, texting and group chat are quickly replacing mobile phone calls and email.

A collaboration platform is a category of business software that adds broad social networking capabilities to work processes. The goal of a collaboration software application is to foster innovation by incorporating knowledge management into business processes so employees can share information and solve business problems more efficiently and in real-time.

Collaboration platforms are replacing email due to their success in enabling real-time communication between employees, team members or partners. Bi-directional communication systems, including collaboration platforms, are generally closed systems. For example, SMS (text) systems communicate bi-directionally with other SMS (text) systems, collaboration platforms communicate bi-directionally within the collaboration platform, and social media platforms such as FACEBOOK, TWITTER, INSTAGRAM, and LINKEDIN enable internal bi-directional communication. Some of these systems enable unidirectional communication between platforms. For example, an INSTAGRAM or TWITTER post may be populated to FACEBOOK, or some social media or collaboration platforms may enable an SMS notification to be sent to a mobile phone. However, these systems do not enable bi-directional multi-platform communication, e.g., by enabling real-time responses back to the original sending platform.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is an example system for environmental context driven collaboration, consistent with embodiments disclosed herein.

FIG. 2 is an example user device for environmental context driven collaboration, consistent with embodiments disclosed herein.

FIG. 3A illustrate an example inter-platform bi-directional communication systems, consistent with embodiments disclosed herein.

FIG. 3B illustrate an example inter-platform bi-directional communication systems, consistent with embodiments disclosed herein.

FIG. 3C illustrate an example inter-platform bi-directional communication systems, consistent with embodiments disclosed herein.

FIG. 3D illustrate an example inter-platform bi-directional communication systems, consistent with embodiments disclosed herein.

FIG. 3E illustrate an example inter-platform bi-directional communication systems, consistent with embodiments disclosed herein.

FIG. 4A illustrates a process for inputting data to a system for environmental context driven collaboration, consistent with embodiments disclosed herein.

FIG. 4B illustrates example application layers for a user interface to a system for environmental context driven collaboration, consistent with embodiments disclosed herein.

FIG. 4C illustrates a user interface to a system for environmental context driven collaboration consistent with embodiments disclosed herein.

FIG. 5A illustrates an example method for interacting with a user interface to a system for environmental context driven collaboration, consistent with embodiments disclosed herein.

FIG. 5B illustrates an example method for interacting with a user interface to a system for environmental context driven collaboration, consistent with embodiments disclosed herein.

FIG. 5C illustrates an example method for interacting with a user interface to a system for environmental context driven collaboration, consistent with embodiments disclosed herein.

FIG. 5D illustrates an example method for interacting with a user interface to a system for environmental context driven collaboration, consistent with embodiments disclosed herein.

FIG. 5E illustrates an example method for interacting with a user interface to a system for environmental context driven collaboration, consistent with embodiments disclosed herein.

FIG. 5F illustrates an example method for interacting with a user interface to a system for environmental context driven collaboration, consistent with embodiments disclosed herein.

FIG. 6A illustrates an example of action triggering functionality of a system for environmental context driven collaboration, consistent with embodiments disclosed herein.

FIG. 6B illustrates an example of action triggering functionality of a system for environmental context driven collaboration, consistent with embodiments disclosed herein.

FIG. 7 illustrates action triggering functionality of a system for environmental context driven collaboration, consistent with embodiments disclosed herein.

FIG. 8 illustrates an example application layering structure for a system for environmental context driven collaboration, consistent with embodiments disclosed herein.

FIG. 9A illustrates an user interface for a system for environmental context driven collaboration, consistent with embodiments disclosed herein.

FIG. 9B illustrates an user interface for a system for environmental context driven collaboration, consistent with embodiments disclosed herein.

FIG. 10 illustrates an example computing component that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments disclosed herein are directed to systems and methods for inter-platform bi-directional communication. More specifically, some embodiments disclosed herein disclose a collaboration interface system communicatively coupled to a plurality of communication platforms, wherein the collaboration interface system is configured to obtain a notification message in a first message format from a first communication, obtain a set of cross-platform encoding parameters, and translate the notification message to a second message format by applying the set of cross-platform communication parameters. In some examples, the set of cross-platform encoding parameters may include one or more application interfaces (“API”) or other types of encoding rules to enable communication with the communication platform. For example, the set of cross-platform encoding rules may include an API from a first social media platform and an API from a second social media platform to enable translation of a message sent from the first social media platform to a format understandable to the second social media platform. As such, the set cross-platform encoding parameters may include a first and a second set of encoding parameters, wherein the first set of encoding parameters corresponds to the first communications platform and the second set of encoding parameters corresponds to the second communications platform. The step of translating the message from the first communication platform may include decoding the message to an intermediate message format using a first set of encoding parameters, and re-encoding the intermediate message to the message format of the second communication platform using a second set of encoding parameters.

The system may transmit the translated notification message to a second communication platform. In some examples, the system may obtain, from the second communication platform, a real-time responsive message, in the second message format, corresponding to the notification message. The system may translate the responsive message to the first message format by applying the set of cross-platform encoding parameters. The system may transit the translated real-time responsive message to the first communication platform.

In some embodiments, the communication platforms may include SMS (texting) systems, such as a mobile phone or cellular communication system, social media systems (e.g., FACEBOOK, TWITTER, LINKEDIN, INSTAGRAM, etc.), or other collaboration systems (e.g., SKYPE, FACEBOOK MESSENGER, WHATSAPP, SLACK, etc.).

The collaboration interface system may include a processor and a non-transitory medium with computer executable instructions embedded thereon. For example, the computer executable instructions may include an interface logical circuit configured to invoke third party collaboration services using API bots, or other application interfaces as known in the art. The third party services may include mass notification services, geolocation triggers, conference calling, bi-directional communication with SMS, bi-directional communication with other collaboration platforms, or other communication services as known in the art.

In some embodiments, the communication interface system may also include a data store with a database stored thereon. The database may include an index identifying system users and corresponding usernames and handles for the system user on each communication platform. The interface logical circuit may be configured to receive system user data, including usernames or handles, from the database to enable the interface logical circuit to properly address inter-platform notification and response messages. In some embodiments, a single notification message may be addressed to one or more users, wherein each user may receive the message on one or more communication platforms. For example, a FACEBOOK user may send a message to a LINKEDIN user, and the LINKEDIN user may also receive the message via SMS and SKYPE, and may respond back from any one of those platforms. The messages may be translated between platform API's by the interface logical circuit and re-addressed using the index.

Some embodiments of the disclosure provide systems and methods for identifying and triggering communications to one or more contacts selected from a target group of contacts based on the contact's a proximity to a geographical region of interest. The geographical region of interest may be manually defined, for example, by using a user interface to select a region of interest relative to a map, or by automated selection using predefined criteria, such as proximity to a natural event (e.g., a weather system or earthquake) or human threat (e.g., a bomb scare or attack). The target group may also be defined using a contact directory and characteristics of each individual within that contact directory. For example, the target group may include characteristics such as affiliation with a first responder organization (e.g., the police or fire department), job duties, demographic data (e.g., a desired target customer for a sale event at a store, or elderly or sick individuals who may be at risk in a heat wave), or other characteristics as known in the art. The triggered communications may include a targeted communication to some or all of the identified contacts from the target group who are located within the geographical region of interest. In some embodiments, the triggered communications include voice calls (e.g., a voice call with one or many parties), chat sessions, text messages, alert notifications, or other types of communications as known in the art.

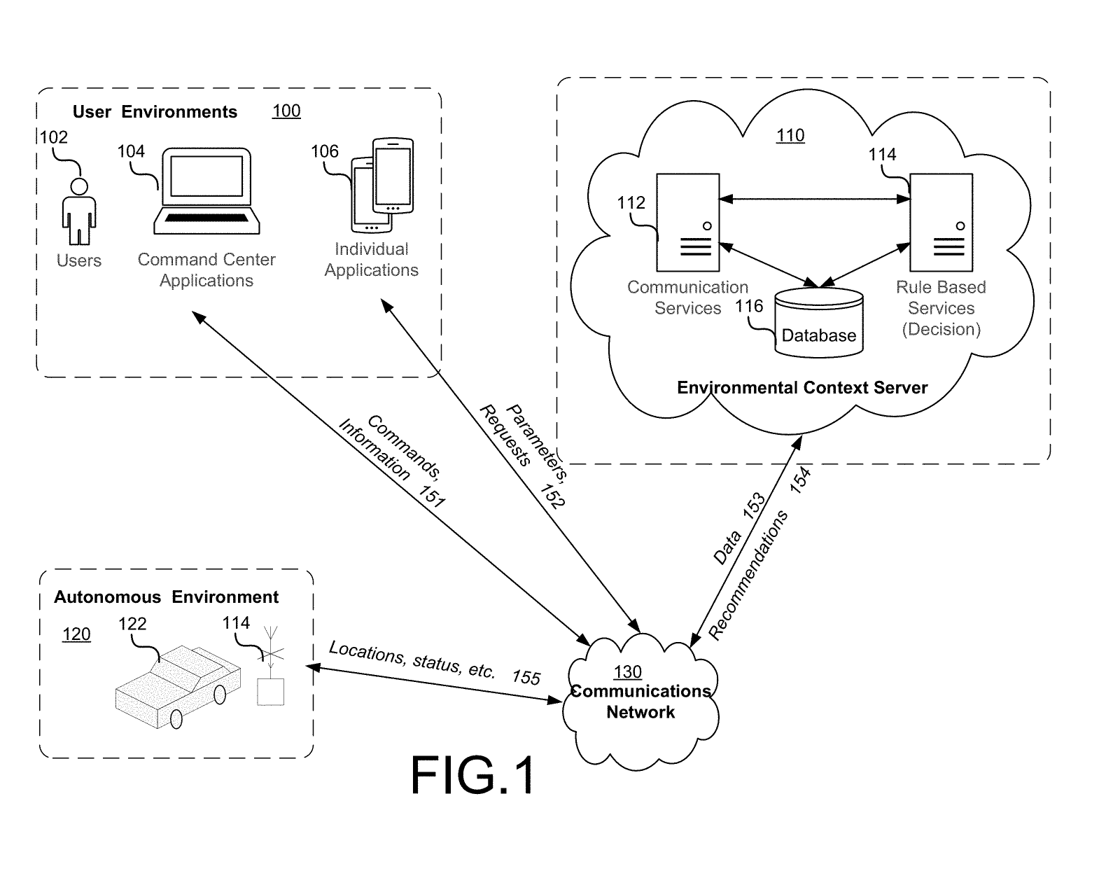

FIG. 1 is an example system for environmental context driven collaboration. Referring to FIG. 1, the system includes user environments 100. For example, user environments 100 may include individual applications 106 and command center applications 104. Users 102 may interface with command center applications 104 and individual applications 106 using computer devices, such as personal computers, laptop computers, tablet computers, smart phones, mobile devices, smart watches, or other computer devices as known in the art. Command center application 104 and individual applications 106 may present users 102 with an user interface configured to enable users 102 to input parameters 152, commands or information 151, or other data into the system. User environment 100 may interface with environmental context server 110 through communications network 130. For example, communications network 130 may be a local area network, a wireless network, a wide area network, the Internet, or other communication networks as known in the art.

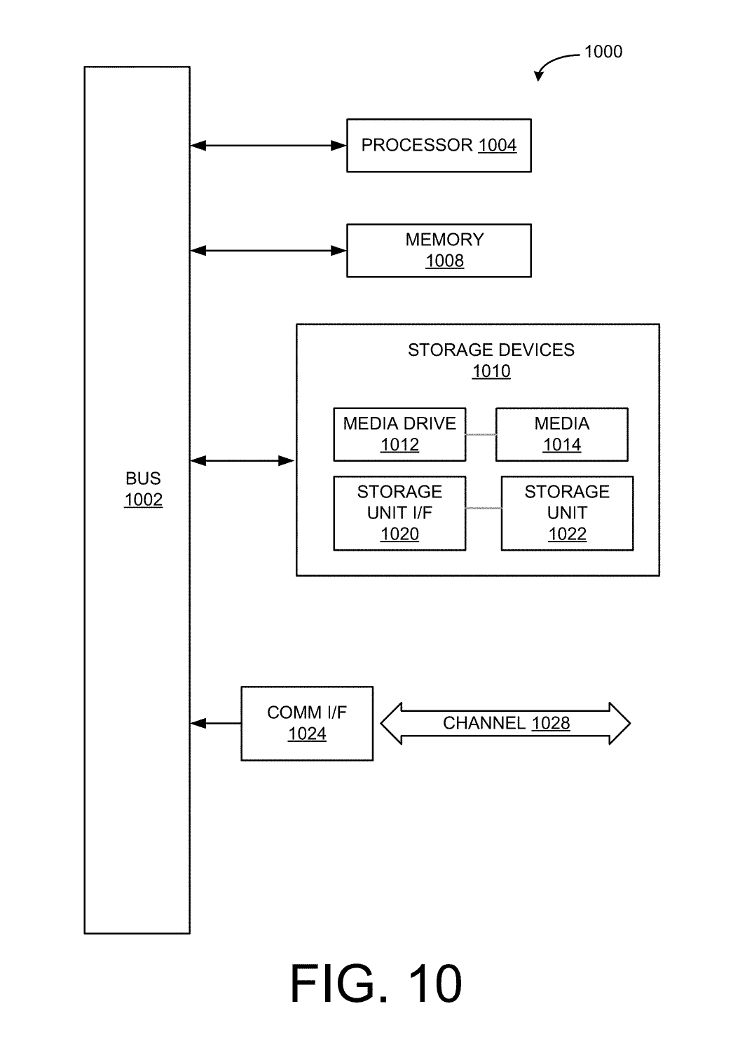

Environmental context server 110 may be local to user environment 100, located in a remote facility, or operated from the cloud. Environmental context server 110 may include various computer components, for example, as identified in FIG. 10 and its related disclosure. In some embodiments, environmental context server 110 may include a processor and a non-transitory computer readable medium with software embedded thereon. Environmental context server 110 may also include database 116. The software may be configured to run communication services 112 and rules-based services 114. In some embodiments, environmental context server 110 may receive commands or information 151, or parameters or requests 152. The software may further be configured to communicate the data to rules-based services 114, or store the data in database 116. Rules-based services 114 may be configured to identify one or more objects (e.g., users, facilities, regions, etc.) that meet thresholds identified by parameters 152.

Environmental context server 110 may also receive data 153 from an autonomous environment 120. For example, autonomous environment 120 may include location identifying equipment 114 (e.g., GPS, wireless location devices, or other location identifying equipment is known in the art). Autonomous environment 120 may also include vehicles 122, drones, weather stations, cameras, or any other devices capable of collecting and transmitting environmental information. For example, environmental information may include location data, weather data, traffic information, information relating to human threats, seismology data, oceanographic data, or other environmental parameters as known in the art.

Users 102 may interact with environmental information collected by autonomous environment 122 via user environment 100. The information may be integrated with environmental parameters received from users 102 and transmitted to and processed by environmental context server 110. In some embodiments, a user 102 may input information 151 (e.g., contact directories, friends lists, social media information, etc.) and then select a geographic region of interest as displayed on a user interface. Environmental context server 110 may generate a subset of the information 151 input by user 102 by correlating information 151 with the selected geographic region of interest to determine, for example, which contacts identified in a user's contact directory are currently located within the geographic region of interest.

Once the subset of information is determined, the user 102 may input commands 151 to rules-based services 114 to interact with the subset of information using communication services 112. For example, communication services 112 may include voice communication, text-based communication, automated alerts or notifications, or other communication services as known in the art.

Rules-based services 114 may also be configured to automatically invoke communication services 112 in reaction to preset triggers. For example, the preset triggers may include thresholds related to traffic information, human threats (e.g., bomb scares, terrorist threats, Amber alerts, missing person alerts, etc.), weather information, proximity information (e.g., proximity to another system user, a store putting on a sale, a region of interest, a human threat, bad weather, etc.), or other detectable information as known in the art.

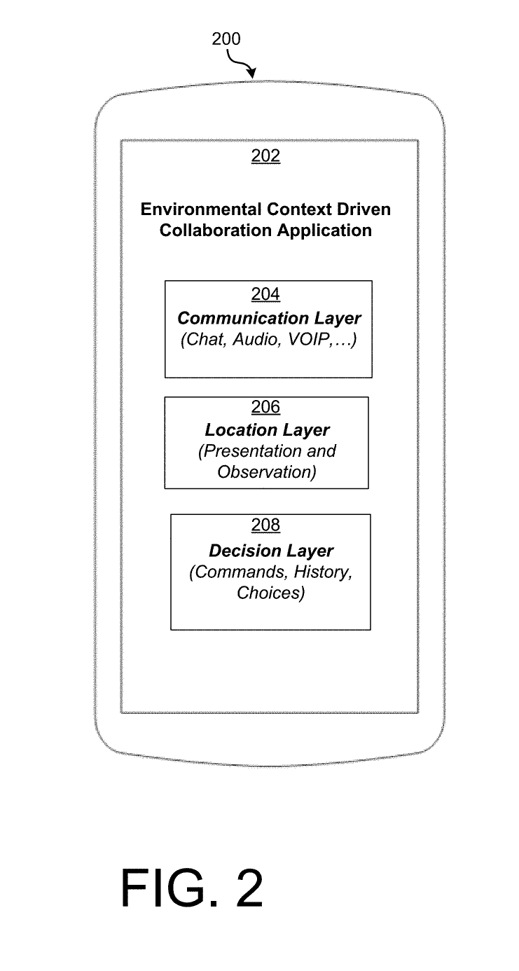

FIG. 2 is an example user device for environmental context driven collaboration. User device 200 may operate within user environment 100, and may be a personal computer, laptop computer, tablet computer, smart phone, mobile device, smart watch, or other input device as known in the art. User device 200 may include components similar to those identified in FIG. 10 and its related disclosure herein. For example, user device 200 may include a processor and a non-transitory computer readable medium with software embedded thereon. The software may be configured to run environmental context driven collaboration application 202. Environmental context driven collaboration application 202 may include a communication layer 204, location layer 206, any decision layer 208. Communications layer 204 may be configured to interface with various communications protocols such as audio, voice over IP (VOIP), chat, text (e.g., SMS), social media (e.g., TWITTER, FACEBOOK, INSTAGRAM, PINTEREST, WAZE, etc.), automated alert protocols, or other communications protocols as known in the art. Location layer 206 may be configured to receive location information from location sensing equipment such as GPS, and present the location information to users 102 through a user interface. Decision layer 208 may be configured to receive commands from the user interface. For example, decision layer 208 may receive a user's contact directory and a user selected geographic region of interest to present a subset of the contact directory correlating with the selected geographic region of interest. Decision layer 208 may also enable the geographic region of interest to be redefined. For example, a first geographic region of interest may be a circle with a first radius. Decision layer 208 may accept input from a user to change the radius of the circle to configure a second geographic region of interest with a second radius. The geographic region of interest may also be a square, a rectangle, a trapezoid, a triangle, a polygon, a free-form shape, or other shapes as known of the art. In some examples, the region of interest may be selected based on other criteria such as the location of roads, waterways, points of interest, etc. The region of interest may be continuous or may include multiple non-continuous segments or sub-regions.

Some embodiments of the disclosure provide a collaboration interface system. For example, the collaboration interface system may include a collaboration interface logical circuit and a data store. The collaboration interface logical circuit may include a processor and a non-transitory medium with computer executable instructions embedded thereon. For example, as discussed above, the computer executable instructions may include an interface logical circuit configured to invoke third party collaboration services using API bots, or other application interfaces as known in the art. The third party services may include mass notification services, geolocation triggers, conference calling, bi-directional communication with SMS, bi-directional communication with other collaboration platforms, or other communication services as known in the art. The collaboration interface logical circuit may be communicatively coupled to one or more collaboration platforms, social media platforms, or other communication systems via the Internet, telephone network, cellular network, WiFi, or other communication networks as known in the art.

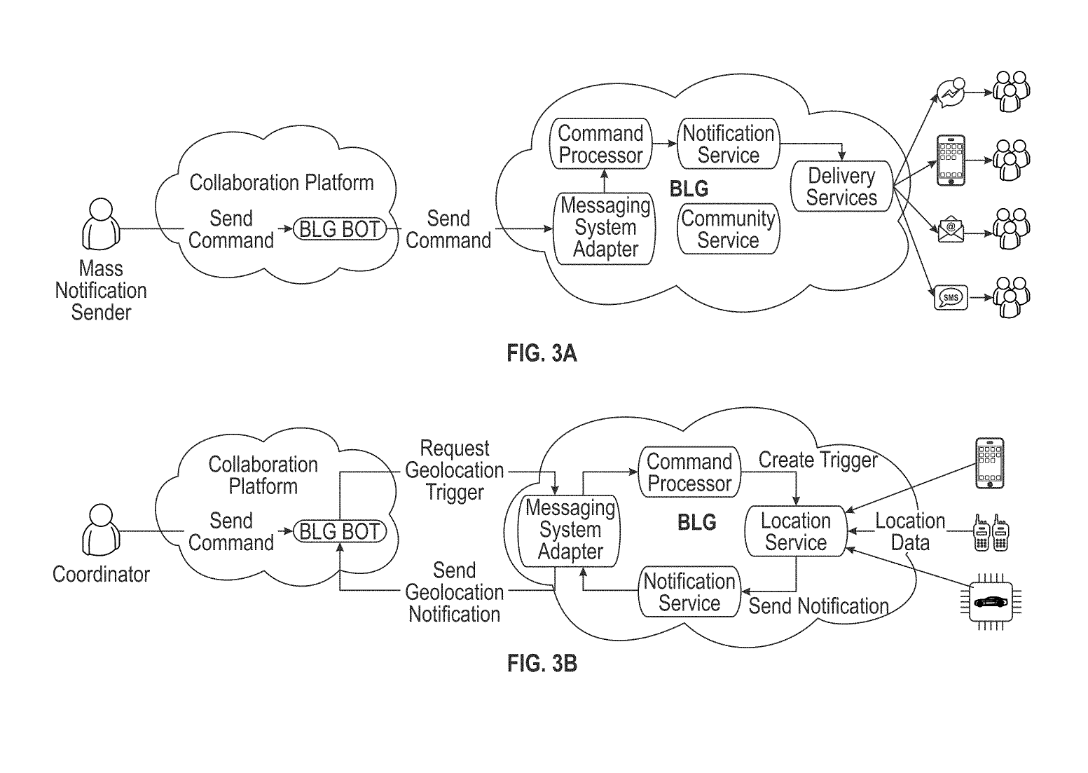

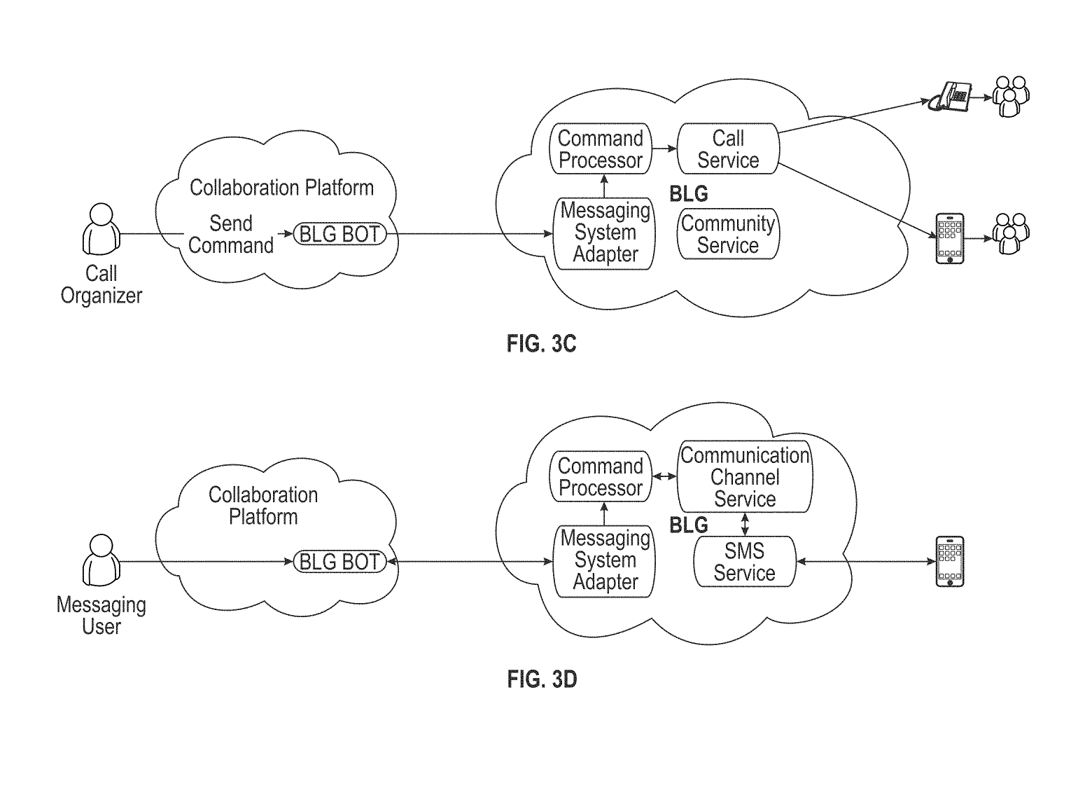

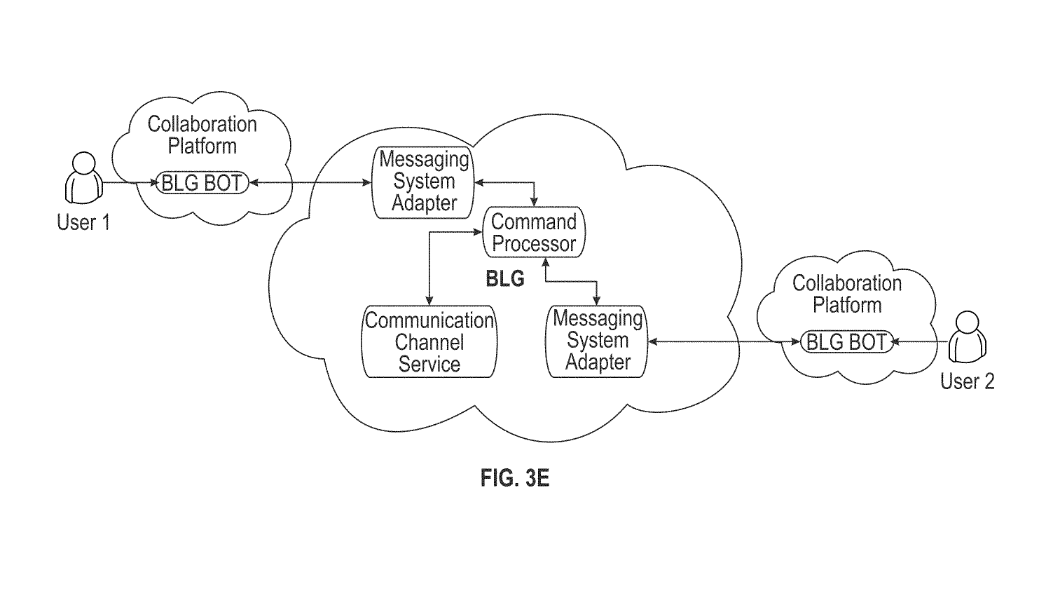

FIG. 3A illustrates an inter-platform bi-directional communication process implemented by a communication interface server. As illustrated, the interface logical circuit may be configured to enable mass notification services, e.g., by receiving a command to send mass notifications from within a collaboration platform or group message application. The notification message may be designed to notify a team, office, division or region with only a few commands from a collaboration system to users that may or may not be on the same platform. In some examples, notifications may be initiated by the interface logical circuit and transmitted to one or more external collaboration platforms via SMS, text-to-voice, email, a companion app, or other collaboration, social media, or communication systems as known in the art. Responses and acknowledgements may then be received by the interface engine and re-broadcast to one or more other collaboration platforms.

As illustrated by FIG. 3A, a user may act as a mass notification sender, e.g., by initiating the mass notification. The mass notification may be initiated by triggering a collaboration platform to send a mass notification from within the collaboration platform using an embedded bot (BLG Bot) in the collaboration platform to users outside the collaboration environment. These users can be discovered via a Community Service, a subsystem that manages the identities and permissions of User 1. The message adapter works through a delivery service that accesses user identity and the identities of their respective delivery channel(s) (such as phone numbers, messenger IDs, email address or mobile numbers). Recipients can then receive messages from the user using a messaging platform, an app, email or SMS and respond back to the collaboration room.

FIG. 3B illustrates an inter-platform bi-directional communication process implemented by a communication interface server. As illustrated, the interface engine may be configured to enable geolocation services, e.g., by receiving a command to request location of individuals, employees, team members or partners. The command may trigger the interface engine to initiate a message to one or more external collaboration platforms requesting to be notified when individuals, employees or partners reach a specific location. The interface engine may also set an alert within the message by individual, device or community name and enter a location or a pre-defined location code (@HQ, @Home etc.). Targeted users in each targeted external collaboration platform will receive alerts message when one or more threshold parameters are triggered (e.g., the user moves within a threshold distance of a specified location).

As illustrated by FIG. 3B, a user may act as an alert coordinator by setting a geolocation for a community of interest users (COI members) using a collaboration platform via the BLG Bot that invokes a messaging service adapter, that manages the trigger via a command processor. Locations for users within one or more external collaboration platforms, or external to any collaboration platform, may be determined according to the location of a geolocation sensing device (e.g., a mobile phone, land mobile radio, GPS, beacon, etc.). Users within one or more collaboration platforms may be notified by the collaboration platform the COI members reach the predefined location. For example, the interface engine may receive an alert form the geolocation device that a first user has come within a threshold proximity of a predefined location. The interface engine may then translate the alert message in accordance with one or more APIs corresponding to one or more collaboration platforms and send the translated alert message to specified users (i.e., the COI members) within the one or more collaboration platforms.

FIG. 3C illustrates an inter-platform bi-directional communication process implemented by a communication interface server. As illustrated, the interface engine may be configured to enable conference calling services. For example, collaboration platform users may initiate a conference call from within a collaboration platform or group message chat with a call command and a call will be executed through a landline or mobile number outside the collaboration platform. The interface engine may receive the request to initiate the call and relay the request using one or more APIs corresponding to one or more collaboration platforms to users within the one or more collaboration platforms. A handshake may then be achieved using the interface engine as an intermediary service to negotiate bidirectional communications (e.g., ACK/NACK).

As illustrated by FIG. 3C, a user may act as a call organizer by initiating a conference call from within a first collaboration platform to users in other collaboration platforms or communication systems, such as desktop or mobile phones. The call organizer may identify groups of conference call recipients by invoking the BLG Bot in a collaboration platform, discover users by communities of interest (by division, region, department for example or function or role), and initiate a conference call instantly wherein all end users need to opt-in.

FIG. 3D illustrates an inter-platform bi-directional communication process implemented by a communication interface server. As illustrated, the interface engine may be configured to enable bi-directional communication from collaboration platform to SMS. For example, the interface engine may receive a message from a first collaboration platform, translate the message using an API in accordance with requirements for bi-directional communication with a second collaboration platform or communication service, such as SMS, and transmit the translated message to the second collaboration platform or communication system. The interface engine may then receive a responsive message from the second collaboration platform or communication system, translate the responsive message using an API in accordance with requirements for the first collaboration platform, and transmit the translated responsive message to the first collaboration platform. For example, as illustrated by FIG. 3D, a user in a collaboration room may send a message via SMS to a group of users outside the platform via SMS and receive a response back into the collaboration platform. As such the interface engine may act as an intermediary or proxy server to negotiate communication between the two or more disparate systems.

FIG. 3D illustrates an inter-platform bi-directional communication process implemented by a communication interface server. As illustrated, the interface engine may be configured to enable bi-directional communication from a first collaboration platform to a second collaboration platform. For example, the interface engine may receive a message from a first collaboration platform, translate the message using an API in accordance with requirements for bi-directional communication with a second collaboration platform, and transmit the translated message to the second collaboration platform or communication system. The interface engine may then receive a responsive message from the second collaboration platform, translate the responsive message using an API in accordance with requirements for the first collaboration platform, and transmit the translated responsive message to the first collaboration platform. For example, as illustrated by FIG. 3E, a user on a collaboration platform may invoke the BLG Bot and sends a message to a user of another collaboration platform and receive a response back.

collaboration platforms or communication systems, such as desktop or mobile phones. The call organizer may identify groups of conference call recipients by invoking the BLG Bot in a collaboration platform, discover users by communities of interest (by division, region, department for example or function or role), and initiate a conference call instantly wherein all end users need to opt-in.

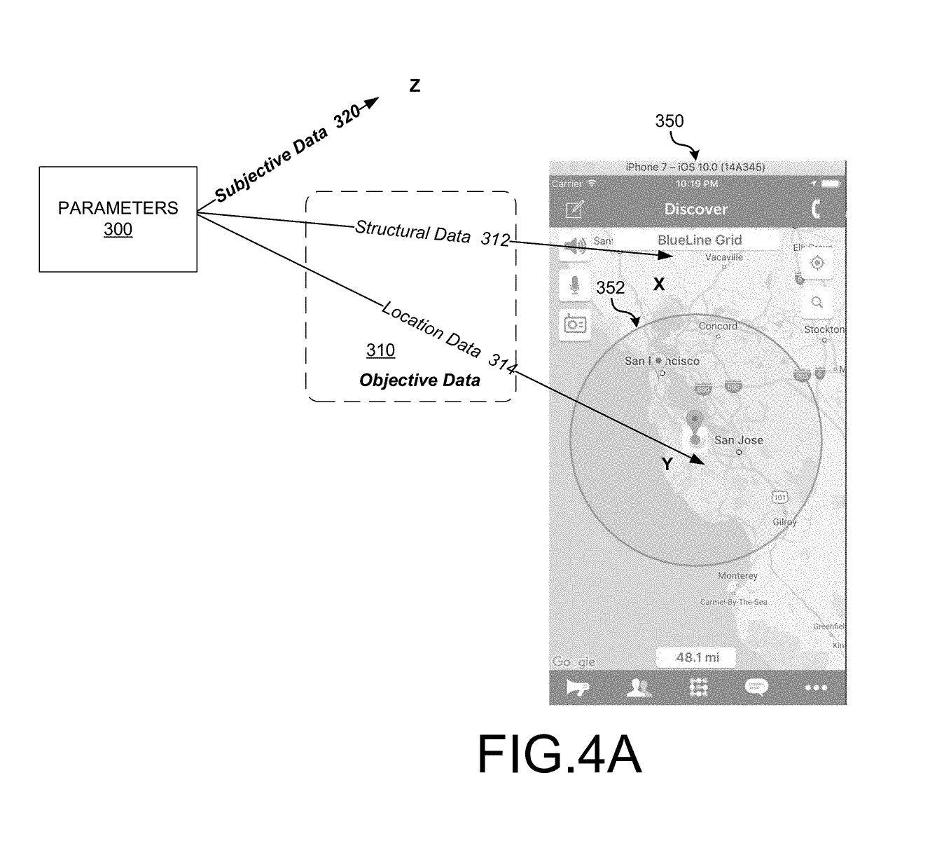

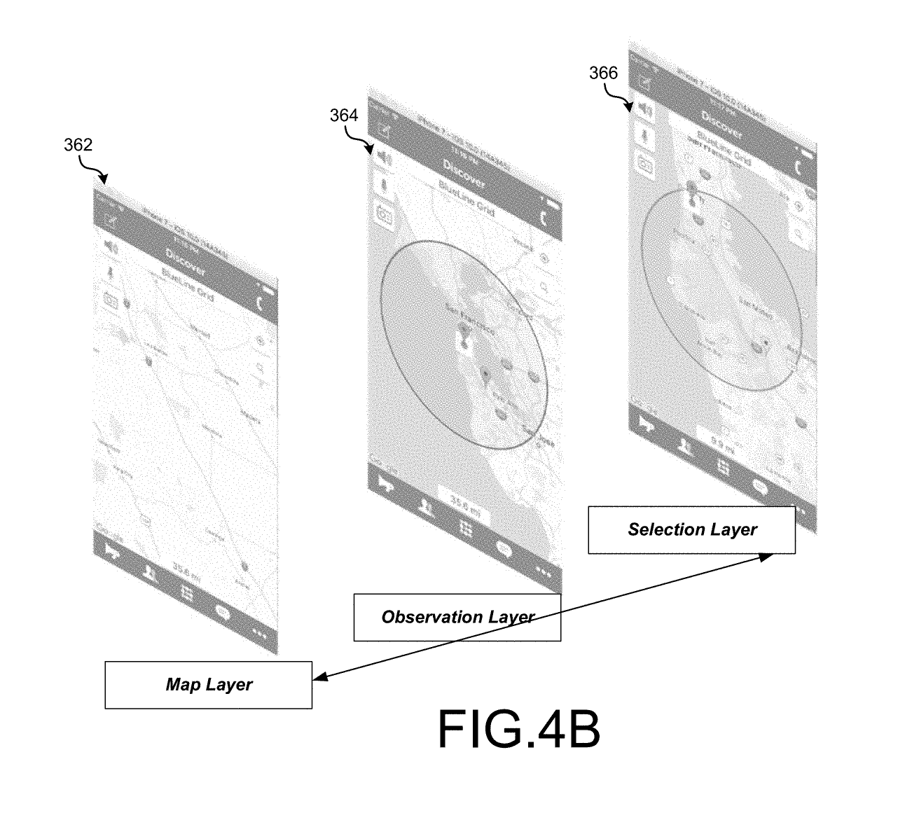

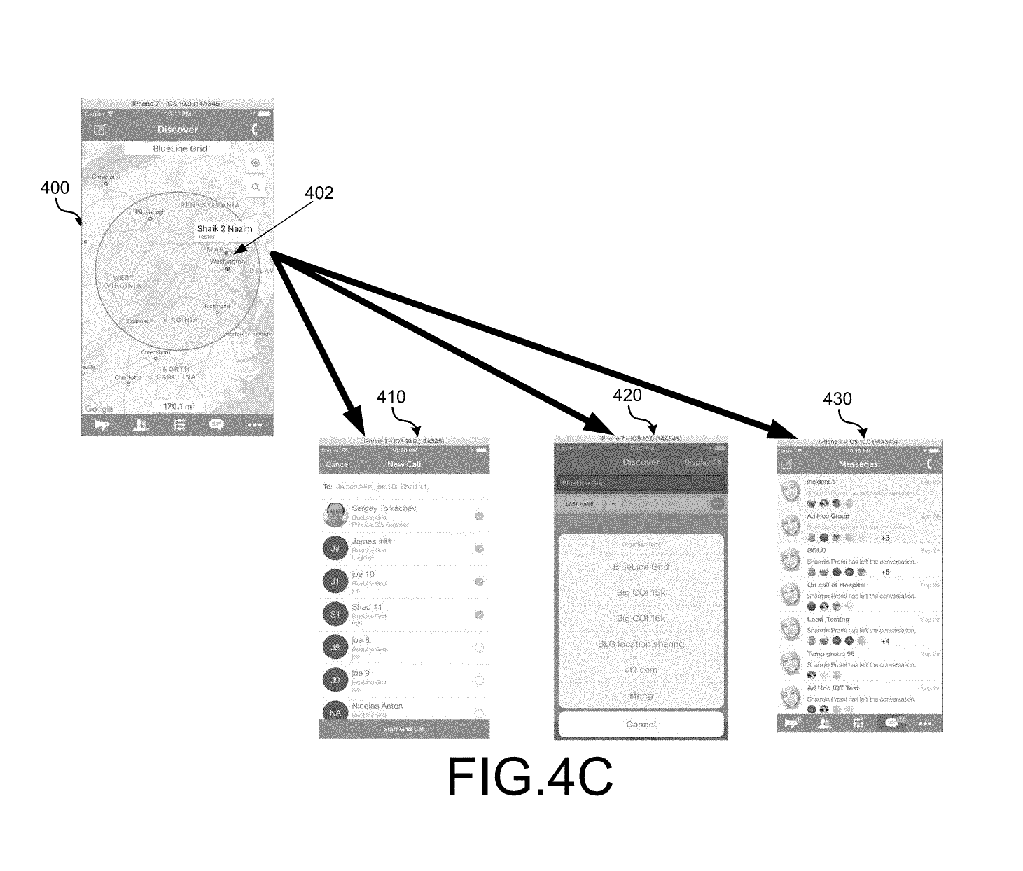

FIG. 4A illustrates a process for inputting data to a system for environmental context driven collaboration. Referring to FIG. 4A, parameters 300 may be input into a user interface 350 operating on environmental context driven application 202. Parameters 300 may include objective data 310 and subjective data 320. Subjective data 320 may include contact directories, geographic regions of interest and related selections, access control lists, user groups, social media information, user preferences, etc. Objective data 310 may include structural data 312 and location data 314. Objective data 310 may also include other environmental parameters such as weather information, seismological information, traffic information, information relating to human threats, or other information relating to a particular location, region, or environment.

Referring to FIG. 4B, user interface 350 may also include map layer 362, observation layer 364, and selection layer 366. Map layer 362 may present a user with cartographic data correlated to the user's location, another user's location, or a selected region. Observation layer 364 may superimpose a first geographic region of interest, i.e., by displaying a region of interest overlay on top of the map. Selection layer 366 and enable the user to adjust the region of interest based on user preferences. For example, the user may zoom in or out of the map to change the relative area displayed within the region of interest overlay, or conversely, may just adjust the size of the region of interest overlay itself is displayed. It should be noted, that although the region of interest overlay is illustrated as a circle in these figures, other shapes or regions may be used as disclosed herein.

FIG. 4C illustrates an example interaction with the user interface. For example, map interface 410 may accept a geographical region of interest selection. In some embodiments, the geographical region of interest selection may be identified relative to a location 402 and adjusted by a user. Group selection interface 420 enables the selection of predefined groups. For example, a predefined group may be ad hoc or based on a user's demographic information, employment information, work location, job duties, corporate division, etc. The environmental context driven communications application may correlate the selected group and predefined alerts with the selected geographic region of interest to generate a group subset and trigger conditions. In some embodiments, if one or more of the trigger conditions is met, predefined alerts may be sent to the group subset, or other actions may be initiated, such as initiation of a voice call or chat messaging session. Voice communication interface 410 may enable a voice call to one or more members of the group subset, and messaging interface 430 may similarly enable messaging communication to the group subset.

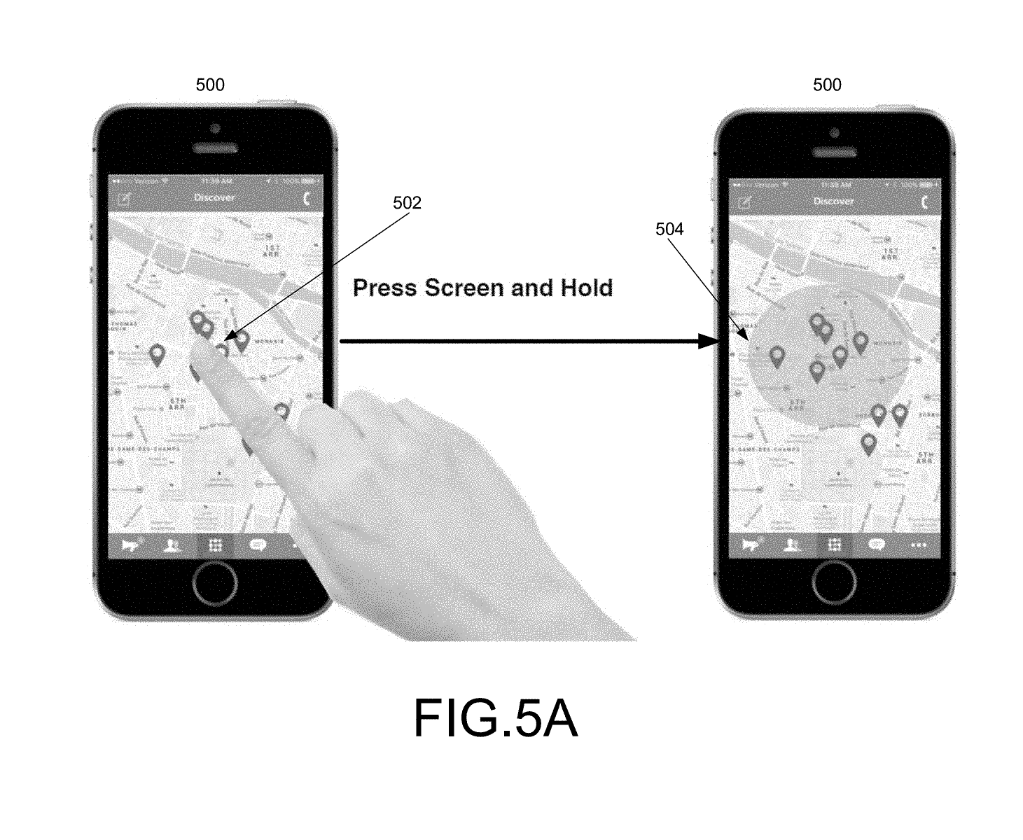

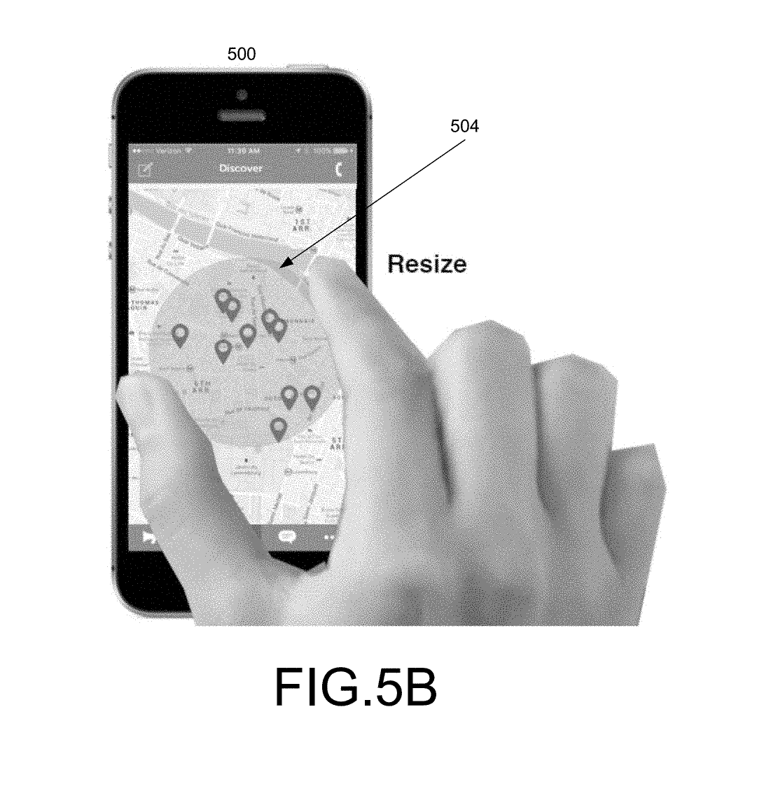

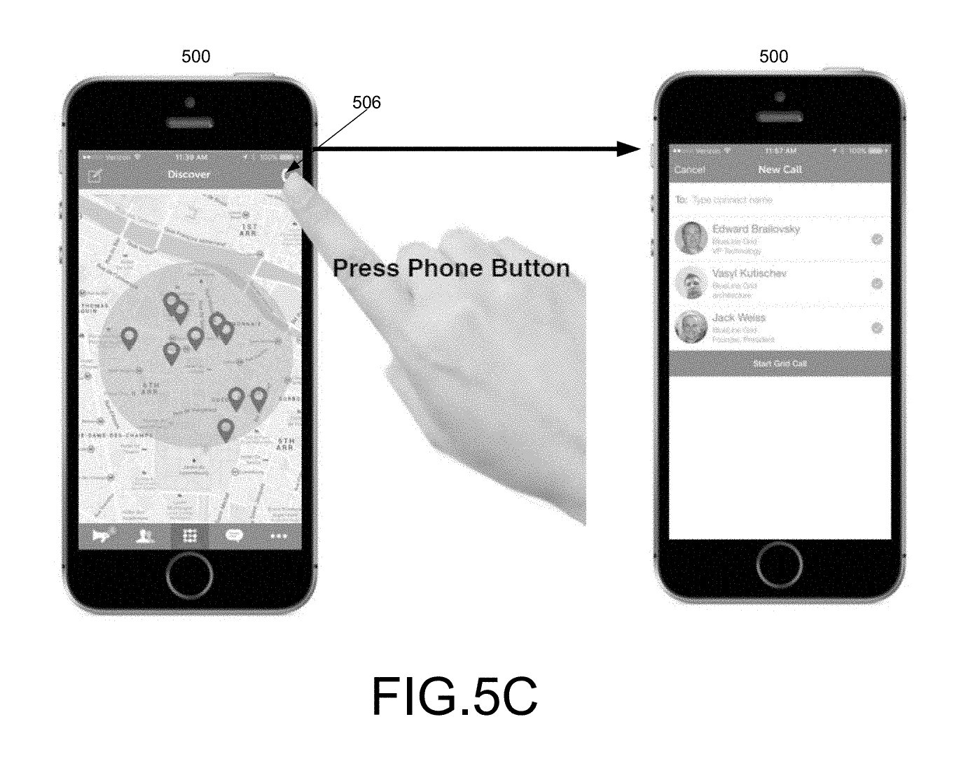

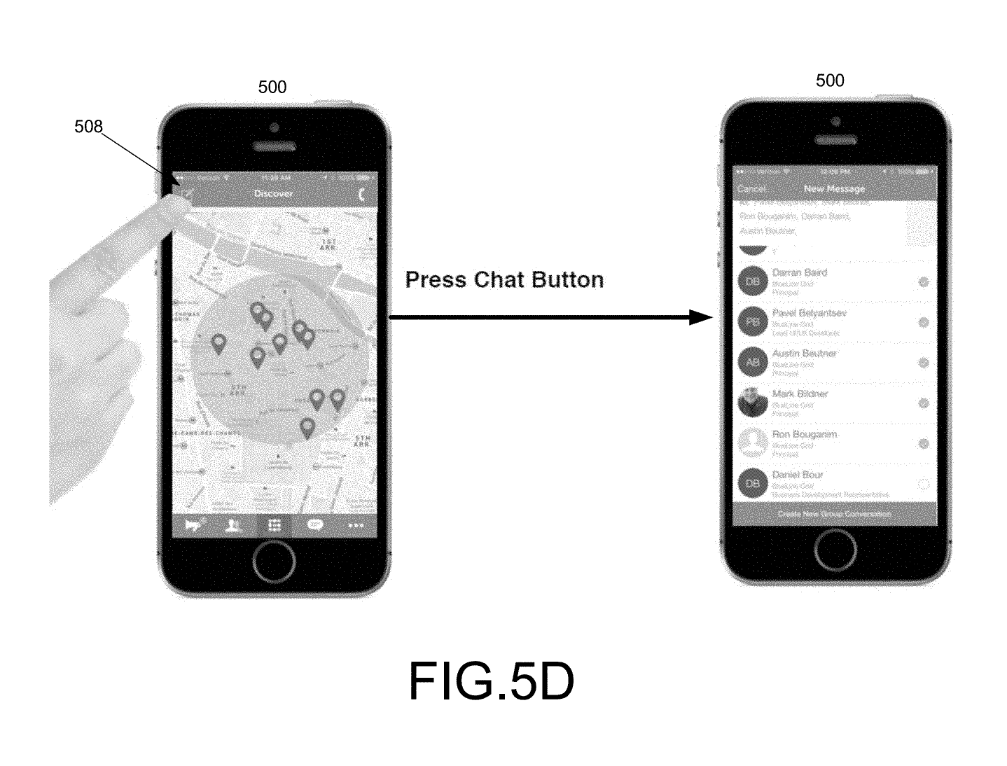

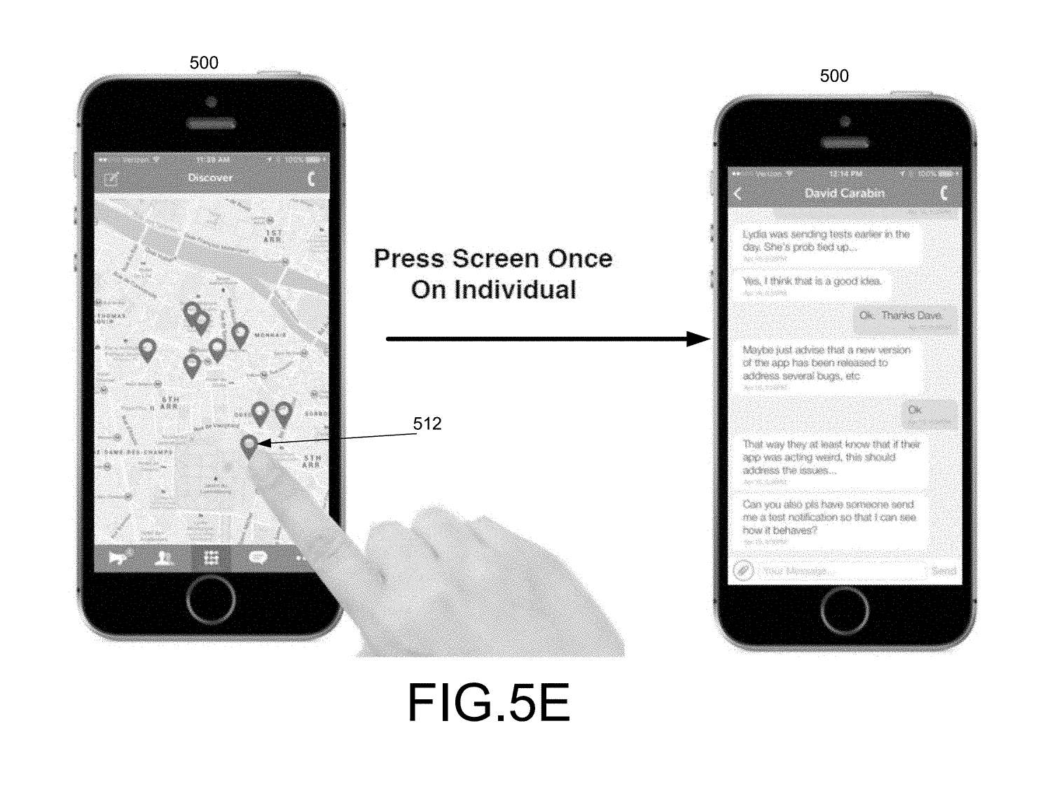

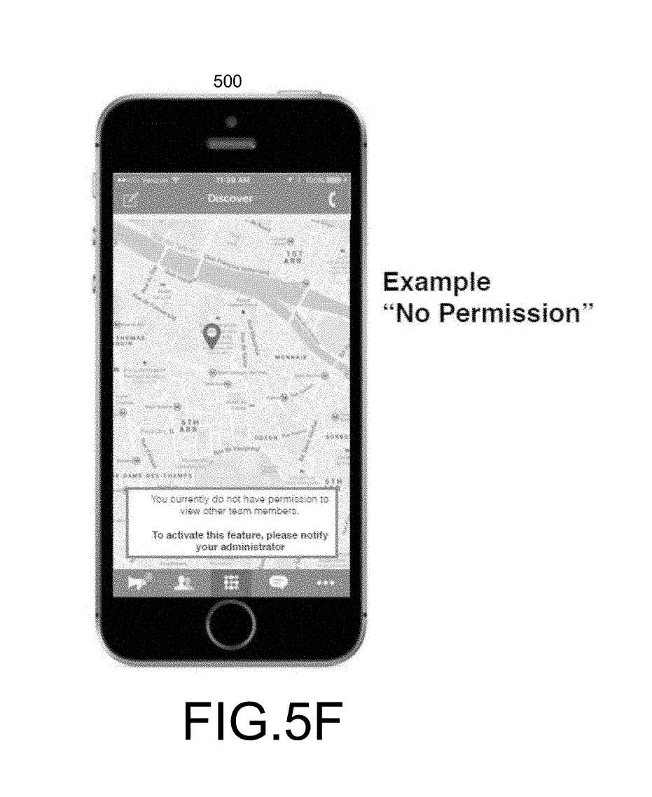

FIGS. 5A-5F illustrate methods for interacting with a user interface to a system for environmental context driven collaboration. Referring to FIG. 5A, a user may select a geographical region of interest by selecting a reference point 502 on a map displayed on a graphical user interface on user input device 500. The selection may be accomplished using a touch input, moving a cursor to the reference point 502 (e.g., using a mouse, touch pad, arrow keys, or other input device), or entering a text-based identifier (e.g., a zip code, address, point of interest description, or other term to identify the region of interest). The selection may alternatively be made using an automated location detection device, such as GPS, to identify the location of the mobile device and automatically identify a region of interest relative to the current location of the mobile device. The geographical region of interest 504 may then be displayed, for example, as an overlay, as illustrated in FIG. 5A.

The geographical regions of interest may initially be displayed using a predetermined radius or area. Although the geographical region of interest 504 is illustrated as a circular region, in some embodiments, the geographical region of interest is a square, a rectangular, a polygonal, a free-form shape, a non-continuous set of regions, or an overlay of landmarks, neighborhood maps, regions defined by zip codes, street boundaries, waterway boundaries, weather pattern shapes, etc. As illustrated in FIG. 5A, a user's contacts from a contact directory may automatically or manually report their locations (e.g., by identifying GPS or other location information as tracked on each user's mobile device), and those locations may also be superimposed on the map displayed on user device 500. The user interface on user device 500 may then identify a subset of the contacts that are located inside of geographical region of interest 504.

Referring to FIG. 5B, geographical region of interest 504 may be resized relative to the map displayed on user device 504 in response to a user input. For example, the user may use a pinching gesture on a touch input device to zoom the map in or out under the region of interest overlay. Alternatively, the pinching gesture may change the size of the geographical region of interest overlay itself. Other input methods may be used as known in the art to adjust the geographical region of interest size, for example, by selecting a magnification level, using arrow keys, using a mouse or other input device, moving the mobile device itself, etc. As the relative size of the geographical region of interest 504 is adjusted with respect to the map display, and dispersion of contacts displayed on the map, additional or fewer contacts may be selected by include or excluding those contacts from the geographical region of interest overlay.

Referring to FIG. 5C, a voice call may be initiated to the entire group of selected contacts (i.e., the group of contacts identified in geographic region of interest 504) in response to a user input. For example, a user may select a voice call button 506 using known user input methods. Alternatively, the user may use a voice command to initiate a call, or may simply raise the phone up to the users ear, with the movement being detected by an accelerometer or other motion detection sensor. Accordingly, a user may initiate a conference call to each identified contact with a single input.

Referring to FIG. 5D, a text based chat or alert may be initiated to the entire group of selected contacts (i.e., the group of contacts identified in geographic region of interest 504) in response to a user input. For example, a user may select a text chat or alert button 508 using known user input methods. Alternatively, the user may use a voice command to initiate a chat, or may use other inputs or short-cut commands as known in the art. Accordingly, a user may initiate a group chat or alert to each identified contact with a single input.

Referring to FIG. 5E, the user may also initiate a call, alert, chat, or other communication session to one or more contacts 512 by selecting the contact or contacts on the user interface displayed on user input device 500, as illustrated. The ability of any user to initiate a communication session, such as a voice call, chat, or alert, to any other user or group of users on the system may be controlled using a permissions system, such as an access control list. For example, as illustrated in FIG. 5F, a communication session to a particular contact or group may be denied if the user does not have permission to communicate with that contact or group. Permissions may be configured for each type of communication, such that a user may be permitted to send text alerts to a particular contact or group, but may not be permitted to make a voice call to that contact or group.

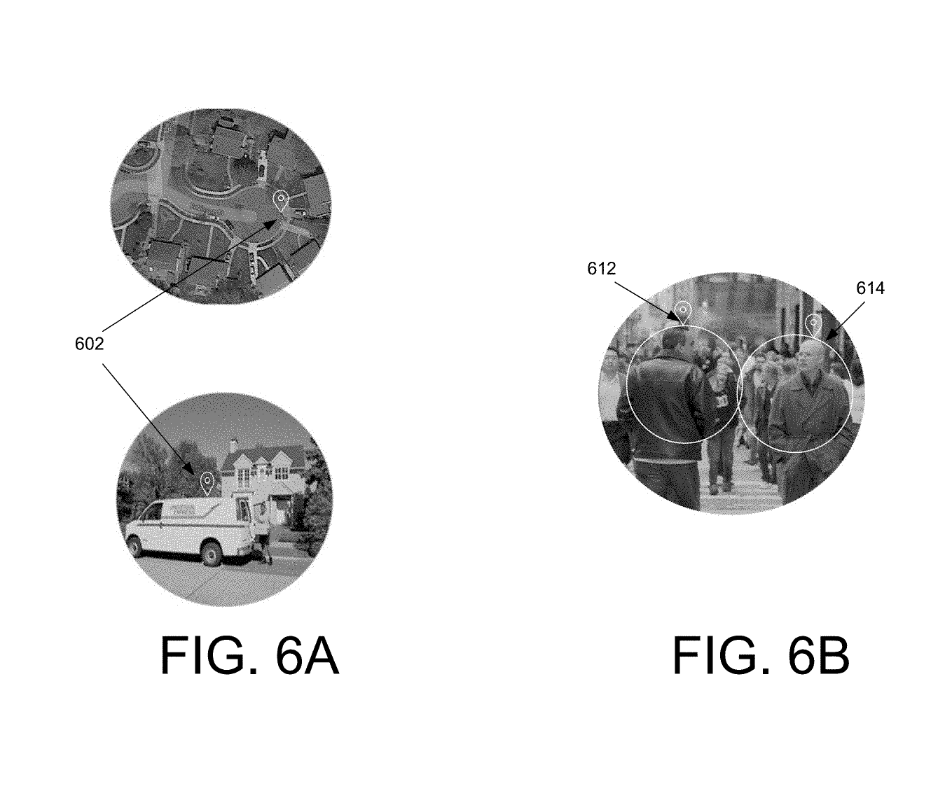

FIGS. 6A-6B illustrate action triggering functionality of a system for environmental context driven collaboration. For example, an action may be initiated when a user comes in proximity of a location 602, as illustrated in FIG. 6A. In some embodiments, an action may be initiated when a first user 612 comes within a predetermined proximity of a second user 614. In some embodiments, the action may be an alert, the initiation of a chat session between the users, or the initiation of a voice all between the users. Similarly, actions may be triggered in response to a user coming within the proximity of an identified geographical region of interest, such as a store, a venue, a neighborhood, a city, or other region, or within proximity of an event, such as a sale, a human threat, an approaching weather system, or a seismologic event. In some examples, the system may be configured to automatically alert all users who come within a predefined proximity of an incoming dangerous weather system. In other examples, the system may be configured to notify users of a nearby sale of merchandise or services, or of a local event. These automated alerts may be implemented using rules based services 114 as illustrated in FIG. 1.

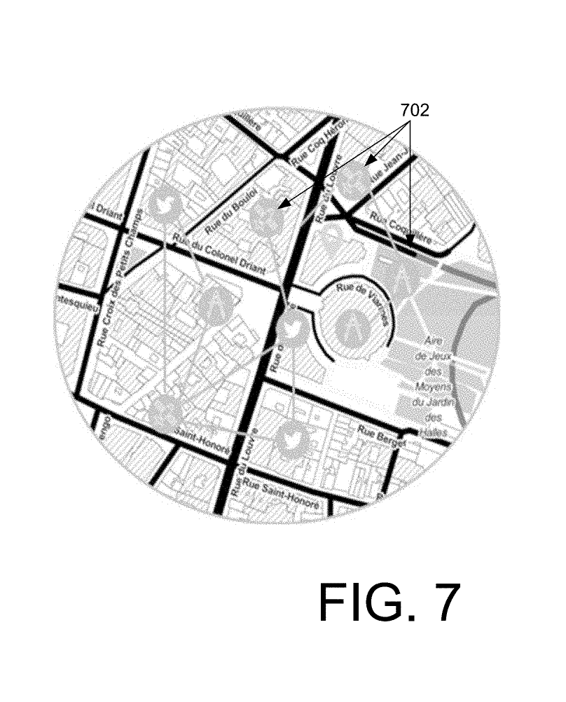

FIG. 7 illustrates action triggering functionality of a system for environmental context driven collaboration. As illustrated in FIG. 7, the system may be configured to initiate actions in response to any of the triggers disclosed herein. The actions may include the use of third party systems 702, such as GPS, chat tools like WHATSAPP or SKYPE, or social media applications such as TWITTER, FACEBOOK, LINKEDIN, INSTAGRAM, or other third party communication tools as known in the art. Actions may include automatic posting of a message using the third party application.

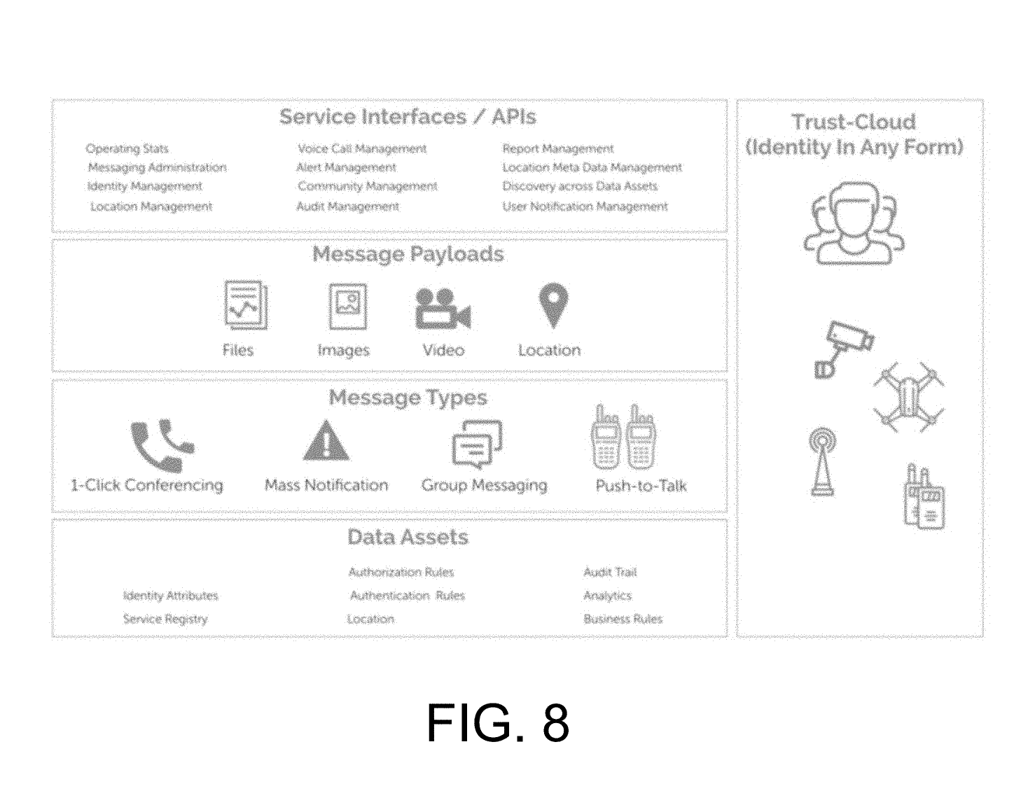

FIG. 8 illustrates an example application layering structure for a system for environmental context driven collaboration. The application layering structures disclosed herein may be used to implement the manual and automatic triggered actions as disclosed herein. As illustrated in FIG. 8, an application layering structure for the system may include service interfaces or API's such as voice call management, alert management, community management, location management, identity management, or other service interfaces and API's as illustrated in FIG. 8 or as known in the art. The application layering structure may also include message payloads (e.g., content), such as filed, images, video, or location data. The application layering structure may also include message types such as 1-click conferencing, mass notifications or alerts, group messaging, push-to-talk, or other message types as known in the art. The application layering structure may also include data assets, such as identity attributes, service registry, authorization rules, authentication rules, locations, access control lists, or other message types as illustrated in FIG. 8 or as known in the art.

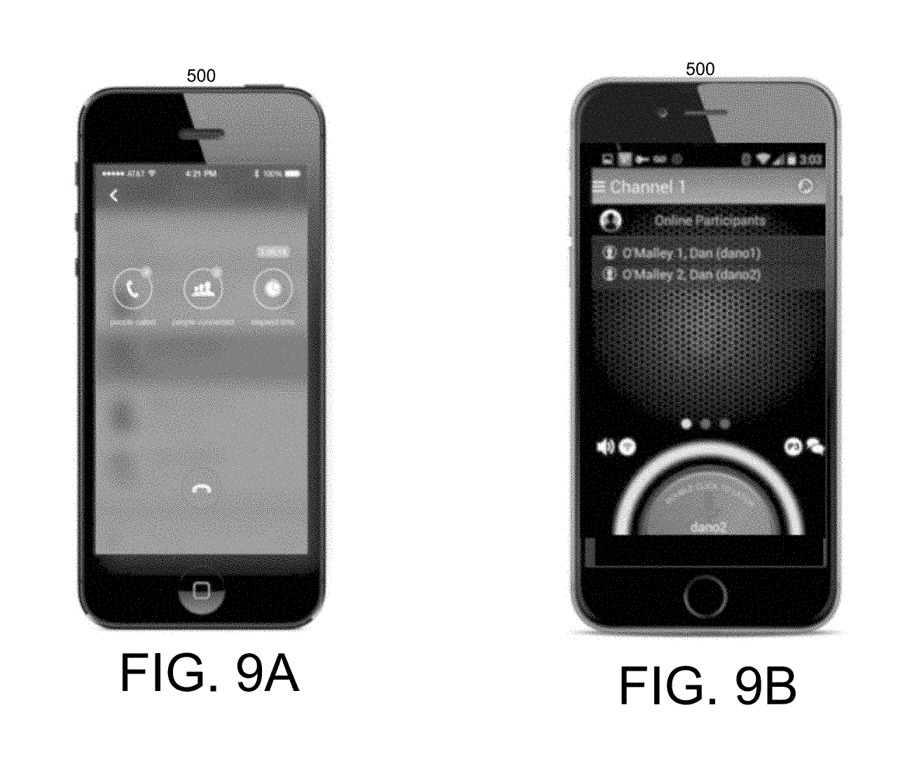

FIGS. 9A-9B illustrate a user interface for a system for environmental context driven collaboration, consistent with embodiments disclosed herein. For example, FIG. 9A shows an example user interface display on user device 500 for implementing a group conference call. FIG. 9B shows an example user interface display on user device 500 for implementing a push-to-talk call. Both of these examples may be initiated using automated or manual location-based triggering methods as disclosed herein.

As used herein, the term component might describe a given unit of functionality that can be performed in accordance with one or more embodiments of the technology disclosed herein. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this description, the various features and functionality described herein may be implemented in any given application and can be implemented in one or more separate or shared components in various combinations and permutations. As used herein, the term engine may describe a collection of components configured to perform one or more specific tasks. Even though various features or elements of functionality may be individually described or claimed as separate components or engines, one of ordinary skill in the art will understand that these features and functionality can be shared among one or more common software and hardware elements, and such description shall not require or imply that separate hardware or software components are used to implement such features or functionality.

Where engines, components, or components of the technology are implemented in whole or in part using software, in one embodiment, these software elements can be implemented to operate with a computing or processing component capable of carrying out the functionality described with respect thereto. One such example computing component is shown in FIG. 10. Various embodiments are described in terms of this example-computing component 1000. After reading this description, it will become apparent to a person skilled in the relevant art how to implement the technology using other computing components or architectures.

Referring now to FIG. 10, computing component 1000 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, digital cameras, navigation systems, cellular telephones, portable computing devices, modems, routers, WAPs, terminals and other electronic devices that might include some form of processing capability.

Computing component 1000 might include a logical circuit including, for example, one or more processors, controllers, control components, or other processing devices, such as a processor 1004. Processor 1004 might be implemented using a general-purpose or special-purpose processing engine such as, for example, a microprocessor, controller, or other control logic. In the illustrated example, processor 1004 is connected to a bus 1002, although any communication medium can be used to facilitate interaction with other components of computing component 1000 or to communicate externally.

Computing component 1000 might also include one or more memory components, simply referred to herein as main memory 1008. For example, preferably random access memory (RAM) or other dynamic memory might be used for storing information and instructions to be executed by processor 1004. Main memory 1008 might also be used for storing temporary variables or other intermediate information during execution of instructions to be executed by processor 1004. Computing component 1000 might likewise include a read only memory (“ROM”) or other static storage device coupled to bus 1002 for storing static information and instructions for processor 804.

The computing component 1000 might also include one or more various forms of information storage device 1010, which might include, for example, a media drive 1012 and a storage unit interface 1020. The media drive 1012 might include a drive or other mechanism to support fixed or removable storage media 1014. For example, a hard disk drive, a floppy disk drive, a magnetic tape drive, an optical disk drive, a CD or DVD drive (R or RW), or other removable or fixed media drive might be provided. Accordingly, storage media 1014 might include, for example, a hard disk, a floppy disk, magnetic tape, cartridge, optical disk, a CD or DVD, or other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing component 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory component) and memory slot, a PCMCIA slot and card, and other fixed or removable storage units 1022 and interfaces 1020 that allow software and data to be transferred from the storage unit 1022 to computing component 1000.

Computing component 1000 might also include a communications interface 1024. Communications interface 1024 might be used to allow software and data to be transferred between computing component 1000 and external devices. Examples of communications interface 1024 might include a modem or softmodem, a network interface (such as an Ethernet, network interface card, WiMedia, IEEE 802.XX, or other interface), a communications port (such as for example, a USB port, IR port, RS232 port, Bluetooth® interface, or other port), or other communications interface. Software and data transferred via communications interface 824 might typically be carried on signals, which can be electronic, electromagnetic (which includes optical) or other signals capable of being exchanged by a given communications interface 1024. These signals might be provided to communications interface 1024 via a channel 1028. This channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1000 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent component names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer implemented method of inter-platform bi-directional collaboration, the method comprising:
obtaining, with a collaboration interface logical circuit, a set of cross-platform encoding parameters;
obtaining, from a first communication platform, a first communication message in a first message format corresponding to the first communication platform;
translating, with the collaboration interface logical circuit, the first communication message in the first message format to a first communication message in a second message format corresponding to a second communication platform, the translating comprising applying the cross-platform encoding parameters; and
transmitting, to the second communication platform, the first communication message in the second message format.

2. The computer implemented method of claim 1, wherein the set of cross-platform encoding parameters comprises an application interface (API) corresponding to the first communication platform or the second communication platform.

3. The computer implemented method of claim 1, further comprising causing the communication message in the first message format to be displayed on a first graphical user interface corresponding to the first communication platform.

4. The computer implemented method of claim 1, further comprising causing the communication message in the second message format to be displayed on a second graphical user interface corresponding to the second communication platform.

5. The computer implemented method of claim 1, wherein the translating the first communication message in the first message format to a first communication message in a second message format comprises:
decoding the first communication message in the first message format to a first communication message in an intermediate message format; and
re-encoding the first communication message in the intermediate message format to the first communication message in the second message format.

6. The computer implemented method of claim 5, wherein the cross-platform encoding parameters comprise a first set of communication parameters corresponding to the first communication platform and a second set of communication parameters corresponding to the second communication platform.

7. The computer implemented method of claim 1, further comprising:
obtaining, from the second communication platform, a second communication message in the second message format;
translating, with the collaboration interface logical circuit, the second communication message in the second message format to a second communication message in the first message format corresponding to the first communication platform; and
transmitting, to the first communication platform, the second communication message in the first message format.

8. The computer implemented method of claim 1, further comprising:
translating, with the collaboration interface logical circuit, the first communication message in the first message format to a first communication message in a third message format corresponding to a third communication platform, the translating comprising applying the cross-platform encoding parameters; and
transmitting, to the third communication platform, the first communication message in the third message format.

9. The computer implemented method of claim 1, wherein the first communication message comprises an alert message, and the obtaining the first communication message comprises receiving a triggering event notification.

10. The computer implemented method of claim 9, wherein the receiving a triggering event notification comprises receiving a first geolocation signal from a first mobile device communicatively coupled to the first communication platform and a second geolocation signal from a second mobile device communicatively coupled to the second communication platform, wherein the first geolocation signal and the second geolocation signal indicate that the first mobile device is located within a threshold distance of the second mobile device.

11. The computer implemented method of claim 9, wherein the receiving a triggering event notification further comprises obtaining an alert indication from a first user interface communicatively coupled to the first communication platform.

12. A system for inter-platform bi-directional collaboration comprising:
a data store and a collaboration interface logical circuit communicatively coupled to a first communication platform and a second communication platform, the collaboration interface logical circuit comprising a processor and a non-transitory computer readable medium with computer executable instructions embedded thereon, the computer executable instructions configured to cause the processor to:
obtain a set of cross-platform encoding parameters from the data store;
obtain, from the first communication platform, a first communication message in a first message format corresponding to the first communication platform;
translate the first communication message in the first message format to a first communication message in a second message format corresponding to the second communication platform by applying the cross-platform encoding parameters; and
transmit, to the second communication platform, the first communication message in the second message format.

13. The system of claim 12, wherein the set of cross-platform encoding parameters comprises an application interface (API) corresponding to the first communication platform or the second communication platform.

14. The system claim 12, wherein the computer executable instructions are further configured to cause the processor to display the communication message in the first message format on a first graphical user interface corresponding to the first communication platform.

15. The system claim 12, wherein the computer executable instructions are further configured to cause the processor to display the communication message in the second message format on a second graphical user interface corresponding to the second communication platform.

16. The system claim 12, wherein the computer executable instructions are further configured to cause the processor to:
Decode the first communication message in the first message format to a first communication message in an intermediate message format; and
re-encode the first communication message in the intermediate message format to the first communication message in the second message format.

17. The system of claim 16, wherein the cross-platform encoding parameters comprise a first set of communication parameters corresponding to the first communication platform and a second set of communication parameters corresponding to the second communication platform.

18. The system of claim 12, wherein the computer executable instructions are further configured to cause the processor to:
obtain, from the second communication platform, a second communication message in the second message format;
translate the second communication message in the second message format to a second communication message in the first message format corresponding to the first communication platform; and
transmit, to the first communication platform, the second communication message in the first message format.

19. The system claim 12, wherein the computer executable instructions are further configured to cause the processor to:
translate the first communication message in the first message format to a first communication message in a third message format corresponding to a third communication platform, the translating comprising applying the cross-platform encoding parameters; and
transmit, to the third communication platform, the first communication message in the third message format.

20. The system of claim 12, wherein the first communication message comprises an alert message triggered in response to a triggering event notification.
